(19) United States
(12) Patent Application Publication
(10) Pub. No.: US 2020/0402123 A1
(43) Pub. Date: Dec. 24, 2020

(54) CONTROL METHODS AND SYSTEMS FOR MULTI-CURRENCY PRICING

(71) Applicant: Shopify Inc., Ottawa (CA)

(72) Inventors: Jesse McGinnis, Waterloo (CA); Zachary Reyno-Chiasson, Waterloo (CA); Colton Pauderis, Waterloo (CA); David Cameron, Kitchener (CA); Yu Liang Tao, Kitchener (CA); Swati Swoboda, Petersburg (CA)

(21) Appl. No.: 16/447,390

(22) Filed: Jun. 20, 2019

(51) Int. Cl. G06Q 30/06; G06Q 40/04

(52) U.S. Cl. CPC G06Q 30/0607; G06Q 40/04; G06Q 30/0631; G06Q 30/0641; G06Q 30/0613

(57) ABSTRACT

Methods and systems for enabling automatic multi-currency pricing may include an e-commerce platform that receives store data corresponding to at least one storefront, wherein the store data includes a corresponding number of visitors to the at least one storefront by jurisdiction or a corresponding amount of product sold by the at least one storefront by jurisdiction. The store data may be evaluated by a pricing engine to determine whether to enable automatic multi-currency pricing, wherein automatic multi-currency pricing determines a corresponding price for at least one product of the at least one storefront in a second currency for a second jurisdiction based on a price in a base currency for a first jurisdiction.

### FIELD

The present disclosure relates generally to an e-commerce platform for managing online and physical stores, and more specifically to control multi-currency pricing for such stores.

### BACKGROUND

Although it may be routine to compute a currency conversion from one currency to another to provide prices for products of stores in different currencies, there may be many reasons that a merchant does not want to provide prices for products in different currencies or to sell products in a particular jurisdiction. These reasons may include considerations of compliance with various laws, rules, or regulations (such as with language requirements) of one or more jurisdictions; considerations regarding taxes and duties; territorial contractual restrictions; exchange rate risk (such as for processing returns); shipping and payment processing complexities; and the like. In addition, a pricing strategy for a merchant often must involve more than a basic computation using the prevailing exchange rate, such as due to the impact of the initial price set in a jurisdiction or local idiosyncrasies of the jurisdiction.

As such, there is a need for methods and systems to assist in determining when to price goods in a given currency and when to avoid simply a basic computation using the prevailing exchange rate, in order to streamline the pricing process and help a merchant increase profit.

### SUMMARY

In embodiments, a computer-implemented method may include receiving, by an e-commerce platform, store data corresponding to at least one storefront, wherein the store data includes at least one of: a corresponding number of visitors to the at least one storefront by jurisdiction and a corresponding amount of product sold by the at least one storefront by jurisdiction. The e-commerce platform may determine a recommendation for the at least one storefront to enable or to disable automatic multi-currency pricing using the store data, wherein automatic multi-currency pricing determines a price for at least one product of the at least one storefront in a second currency for a second jurisdiction based on a price of the product in a base currency for a first jurisdiction. The e-commence platform may communicate the recommendation to a merchant user associated with the at least one storefront.

In embodiments, determining the recommendation may consider a number of visitors to the at least one storefront from the second jurisdiction. A recommendation to enable automatic multi-currency pricing may occur if a number of visitors to the at least one storefront from the second jurisdiction is above a predetermined amount or a rate of change of the number of visitors to the at least one storefront from the second jurisdiction is above a predetermined value. A recommendation to enable automatic multi-currency pricing may occur if the amount of product sold in the second jurisdiction is above a predetermined value. The store data may include data from multiple storefronts and determining the recommendation may consider the data from multiple storefronts. Determining the recommendation may include aggregating the data from multiple storefronts according to a selected industry or a classification of product. Determining the recommendation may consider a number of visitors to the multiple storefronts from the second jurisdiction. A recommendation to enable multi-currency pricing may occur if a number of visitors to the at least one storefront from the second jurisdiction is above a predetermined amount or a rate of change of the number of visitors to the at least one storefront from the second jurisdiction is above a predetermined value. The store data may include data from multiple storefronts and determining the recommendation may include aggregating the data from multiple storefronts according to a selected industry or a classification of product. A recommendation to enable multi-currency may occur if an amount of product sold in the second jurisdiction for the multiple storefronts is above a predetermined value. A corresponding price for a product in the base currency or the second currency may be set in accordance with an exchange rate computation. A corresponding price for a product in the base currency or the second currency may be set using an exchange rate between the base currency and the second currency. A recommendation to enable multi-currency pricing may be based on an exchange rate stability factor. The e-commerce platform may create a product variant page for the second jurisdiction. Associated data may be provided for the product variant page including a price, a corresponding date and time the price was set, a corresponding exchange rate application when the price was set, whether a price may beset manually or automatically, and/or whether a recommendation to enable multi-currency pricing was followed. Determining updated recommendations may be repeated at predetermined intervals. The store data may correspond to at least one storefront over a set period of time.

In embodiments, a computer-implemented method may include receiving, by an e-commerce platform, store data corresponding to at least one storefront, wherein the store data may include at least one of: a corresponding number of visitors to the at least one storefront by jurisdiction and a corresponding amount of product sold by the at least one storefront by jurisdiction. The e-commerce platform may determine whether to enable automatic multi-currency pricing using the store data, wherein automatic multi-currency pricing determines a corresponding price for at least one product of the at least one storefront in a second currency for a second jurisdiction based on a price in a base currency for a first jurisdiction. The e-commerce platform may enable automatic multi-currency pricing for the at least one product of the at least one storefront in accordance with the determining step.

The determining step may consider a number of visitors to the at least one storefront from the second jurisdiction. Automatic multi-currency pricing may be enabled if a number of visitors to the at least one storefront from the second jurisdiction is above a predetermined amount or a rate of change of the number of visitors to the at least one storefront from the second jurisdiction is above a predetermined value. Automatic multi-currency pricing may be enabled if an amount of product sold in the second jurisdiction is above a predetermined value. The store data may include data from multiple storefronts. The determining step may include aggregating the data from multiple storefronts according to a selected industry or a classification of product. The determining step may consider a number of visitors to the at least one storefront from the second jurisdiction. Automatic multi-currency pricing may be enabled if a number of visitors to the at least one storefront from the second jurisdiction is above a predetermined amount or a rate of change of the number of visitors to the at least one storefront from the second jurisdiction is above a predetermined value. Automatic multi-currency pricing may be enabled if an amount of product sold in the second jurisdiction is above a predetermined value. Corresponding prices for each product of the at least one storefront may be determined in the second currency based on the base currency and an exchange rate between the second currency and the base currency. A determination to enable automatic multi-currency pricing may be based on an exchange rate stability factor. A determination to enable automatic pricing may be applied to all products of the at least one storefront. The e-commerce platform may prepare a product variant page for the second jurisdiction. The e-commerce platform may provide associated data for the product variant page including a price, a corresponding date and time the price was set, a corresponding exchange rate application when the price was set, and/or whether a price may be set manually or automatically. The determining step may be repeated at predetermined intervals. The store data may correspond to at least one storefront over a set period of time.

In embodiments, a system may include an e-commerce platform comprising at least one processor and at least one memory. The e-commerce platform may be adapted to receive store data corresponding to at least one storefront, wherein the store data may include at least one of: a corresponding number of visitors to the at least one storefront by jurisdiction and a corresponding amount of product sold by the at least one storefront by jurisdiction. The system may include a pricing engine adapted to determine a recommendation for the at least one storefront to enable or to disable automatic multi-currency pricing using the store data, wherein automatic multi-currency pricing determines a price for at least one product of the at least one storefront in a second currency for a second jurisdiction based on a price of the product in a base currency for a first jurisdiction. The e-commerce platform may be adapted to communicate the recommendation to a merchant user associated with the at least one storefront.

The recommendation may be determined by considering a number of visitors to the at least one storefront from the second jurisdiction. A recommendation to enable automatic multi-currency pricing may occur if a number of visitors to the at least one storefront from the second jurisdiction is above a predetermined amount or a rate of change of the number of visitors to the at least one storefront from the second jurisdiction is above a predetermined value. A recommendation to enable automatic multi-currency pricing may occur if the amount of product sold in the second jurisdiction is above a predetermined value. The store data may include data from multiple storefronts and the recommendation may be determined by considering the data from multiple storefronts. The recommendation may be determined by aggregating the data from multiple storefronts according to a selected industry or a classification of product. The recommendation may be determined by considering a number of visitors to the multiple storefronts from the second jurisdiction. A recommendation to enable multi-currency pricing may occur if a number of visitors to the at least one storefront from the second jurisdiction is above a predetermined amount or a rate of change of the number of visitors to the at least one storefront from the second jurisdiction is above a predetermined value. The store data may include data from multiple storefronts and the recommendation may be determined by aggregating the data from multiple storefronts according to a selected industry or a classification of product. A recommendation to enable multi-currency may occur if an amount of product sold in the second jurisdiction for the multiple storefronts is above a predetermined value. A corresponding price for a product in the base currency or the second currency may be set in accordance with an exchange rate computation. A corresponding price for a product in the base currency or the second currency may be set using an exchange rate between the base currency and the second currency. A recommendation to enable multi-currency pricing may be based on an exchange rate stability factor. The e-commerce platform may be enabled to create a product variant page for the second jurisdiction. In embodiments, the e-commerce platform may be enabled to provide associated data for the product variant page including at least one item selected from the group consisting of: a price, a corresponding date and time the price was set, a corresponding exchange rate application when the price was set, whether a price is set manually or automatically, and whether a recommendation to enable multi-currency pricing was followed. In embodiments, an updated recommendation may be determined at predetermined intervals. The store data may correspond to at least one storefront over a set period of time.

In embodiments, an e-commerce platform may comprise at least one processor and at least one memory, wherein the e-commerce platform may be adapted to receive store data corresponding to at least one storefront, wherein the store data may include at least one of: a corresponding number of visitors to the at least one storefront by jurisdiction and a corresponding amount of product sold by the at least one storefront by jurisdiction. A pricing engine may be adapted to determine whether to enable automatic multi-currency pricing using the store data, wherein automatic multi-currency pricing determines a corresponding price for at least one product of the at least one storefront in a second currency for a second jurisdiction based on a price in a base currency for a first jurisdiction, wherein automatic multi-currency pricing for the at least one product of the at least one storefront is enabled in accordance with the determining step.

A determination of whether to enable multi-currency pricing may consider a number of visitors to the at least one storefront from the second jurisdiction. Automatic multi-currency pricing may be enabled if a number of visitors to the at least one storefront from the second jurisdiction is above a predetermined amount or a rate of change of the number of visitors to the at least one storefront from the second jurisdiction is above a predetermined value. Automatic multi-currency pricing may be enabled if an amount of product sold in the second jurisdiction is above a predetermined value. The store data may include data from multiple storefronts. A determination of whether to enable multi-currency pricing may consider aggregated data from multiple storefronts according to a selected industry or a classification of product. A number of visitors to the at least one storefront from the second jurisdiction may be considered in a determination of whether to enable multi-currency pricing. Automatic multi-currency pricing may be enabled if a number of visitors to the at least one storefront from the second jurisdiction is above a predetermined amount or a rate of change of the number of visitors to the at least one storefront from the second jurisdiction is above a predetermined value. Automatic multi-currency pricing may be enabled if an amount of product sold in the second jurisdiction is above a predetermined value. Corresponding prices for each product of the at least one storefront may be determined in the second currency based on the base currency and an exchange rate between the second currency and the base currency. A determination to enable automatic multi-currency pricing may be based on an exchange rate stability factor. A determination to enable automatic pricing may be applied to all products of the at least one storefront. The e-commerce platform may provide a product variant page for the second jurisdiction. The e-commerce platform may provide associated data for the product variant page including at least one item selected from the group consisting of: a price, a corresponding date and time the price was set, a corresponding exchange rate application when the price was set, and whether a price is set manually or automatically.

In embodiments, a method may include receiving, by an e-commerce platform, product data corresponding to a product of at least one storefront, wherein the product data relates to a first jurisdiction. The e-commerce platform may determine whether to override a first price for the product using the product data, wherein the first price for the product is generated using automatic multi-currency pricing in a first currency for a first jurisdiction based on a base price of the product in a base currency and an exchange rate calculation. The first price for the product of the at least one storefront may be overridden in accordance with the determining step.

The product data may include a cost to supply the product to the first jurisdiction, a factor related to purchasing power of the first jurisdiction, a demand for the product in the first jurisdiction, a supply of the product in the first jurisdiction, a stability factor related to a currency of the first jurisdiction, competitor pricing of the product in the first jurisdiction, a volume of sales of the product in the first jurisdiction, and/or competitor sales of the product in the first jurisdiction. The product data may include a total cost of the product in the first jurisdiction including any storage costs, tax costs, import costs, local production costs, and labor costs and the first price may be overridden if the total cost of a product is greater than a predetermined amount. The product data may include a number of visitors to the at least one storefront from the first jurisdiction and the first price may be overridden if a number of visitors to the at least one storefront from the first jurisdiction is above a predetermined amount and a total amount of sales is below a predetermined value. The product data may include data from multiple storefronts, and the determining step may include aggregating the data from multiple storefronts according to a selected industry or a classification of product. The product data may include an average total cost of a product in the first jurisdiction across the multiple storefronts including any storage costs, tax costs, import costs, local production costs, and labor costs and the first price may be overridden if the average total cost of a product is greater than a predetermined amount. The determining step may examine attitudes toward a product in the first jurisdiction. The determining step may include machine learning. A command for allowing automatic multi-currency pricing prior to or subsequent to an action overriding the first price may be received by the e-commerce platform. A determination to override the first price may be based on an exchange rate stability factor with respect to the first currency and the base currency. A determination to override a price that is generated by automatic multi-currency pricing may be applied to a selection of products or all products of the at least one storefront. The e-commerce platform may create a corresponding product variant page for the first jurisdiction and provide for each product variant page associated data including a price, a corresponding date and time the price was set, a corresponding exchange rate application when the price was set, and/or whether a price may be set manually or automatically. The determining step may be repeated at predetermined intervals. The e-commerce platform may receive an updated price for the product in the first currency. The product may be made unavailable in the first jurisdiction if the first price is overridden and an updated price for the product in the first currency has not been received by the e-commerce platform.

In embodiments, a method may include receiving, by an e-commerce platform, product data corresponding to a product of at least one storefront, wherein the product data relates to a first jurisdiction and determining, by the e-commerce platform, a recommendation to override or to not override a first price for the product using the product data, wherein the first price for the product is generated using automatic multi-currency pricing in a first currency for a first jurisdiction based on a base price of the product in a base currency and an exchange rate calculation. The e-commerce platform may communicate the recommendation to a merchant user associated with the at least one storefront.

The product data may include a cost to supply the product to the first jurisdiction, a factor related to purchasing power of the first jurisdiction, a demand for the product in the first jurisdiction, a supply of the product in the first jurisdiction, a stability factor related to a currency of the first jurisdiction, competitor pricing of the product in the first jurisdiction, a volume of sales of the product in the first jurisdiction, and/or competitor sales of the product in the first jurisdiction. The product data may include a total cost of the product in the first jurisdiction including any storage costs, tax costs, import costs, local production costs, and labor costs and a recommendation to override the first price may be provided if the total cost of a product is greater than a predetermined amount. The product data may include a number of visitors to the at least one storefront from the first jurisdiction and a recommendation to override the first price may occur if a number of visitors to the at least one storefront from the first jurisdiction is above a predetermined amount and a total amount of sales is below a predetermined value. The product data may include data from multiple storefronts. The recommendation may be determined by aggregating the data from multiple storefronts according to a selected industry or a classification of product. The product data may include an average total cost of a product in the first jurisdiction across the multiple storefronts including any storage costs, tax costs, import costs and a recommendation to override the first price may occur if local production costs, and labor costs and the average total cost of a product is greater than a predetermined amount. Attitudes toward a product in the first jurisdiction may be examined to determine a recommendation. A recommendation may be determined using machine learning. The e-commerce platform may receive a command for allowing automatic multi-currency pricing prior to or subsequent to providing a recommendation to override the first price. A recommendation to override the first price may occur based on an exchange rate stability factor with respect to the first currency and the base currency. A recommendation to override a price generated by automatic multi-currency pricing may be applied to a selection of products or all products of the at least one storefront. The e-commerce platform may create a corresponding product variant page for the first jurisdiction and provide for each product variant page associated data including a price, a corresponding date and time the price was set, a corresponding exchange rate application when the price was set, whether a recommendation to override may be provided, and/or whether a price is set manually or automatically. An updated recommendation may be determined at predetermined intervals. The e-commerce platform may receive an updated price for the product in the first currency. The product may be made unavailable in the first jurisdiction if a recommendation to override the first price is provided and an updated price for the product in the first currency has not been received by the e-commerce platform.

In embodiments, a system may include an e-commerce platform comprising at least one processor and at least one memory, wherein the e-commerce platform is adapted to receive product data corresponding to a product of at least one storefront, wherein the product data relates to a first jurisdiction. A pricing engine may be adapted to determine whether to override a first price for the product using the product data, wherein the first price for the product is generated using automatic multi-currency pricing in a first currency for a first jurisdiction based on a base price of the product in a base currency and an exchange rate calculation. The e-commerce platform may be adapted to override the first price for the product of the at least one storefront in accordance with the determining step.

The product data may include a cost to supply the product to the first jurisdiction, a factor related to purchasing power of the first jurisdiction, a demand for the product in the first jurisdiction, a supply of the product in the first jurisdiction, a stability factor related to a currency of the first jurisdiction, competitor pricing of the product in the first jurisdiction, a volume of sales of the product in the first jurisdiction, and/or competitor sales of the product in the first jurisdiction. The product data may include a total cost of the product in the first jurisdiction including any storage costs, tax costs, import costs, local production costs, and labor costs and the first price may be overridden if the total cost of a product is greater than a predetermined amount. The product data may include a number of visitors to the at least one storefront from the first jurisdiction and the first price may be overridden if a number of visitors to the at least one storefront from the first jurisdiction is above a predetermined amount and a total amount of sales is below a predetermined value. The product data may include data from multiple storefronts, and the data from multiple storefronts may be aggregated according to a selected industry or a classification of product. The product data may include an average total cost of a product in the first jurisdiction across the multiple storefronts including any storage costs, tax costs, import costs, local production costs, and labor costs and the first price may be overridden if the average total cost of a product is greater than a predetermined amount. Attitudes toward a product in the first jurisdiction may be examined by the pricing engine. The pricing engine may employ machine learning. The e-commerce platform may receive a command for allowing automatic multi-currency pricing prior to or subsequent to an action overriding the first price. A determination to override the first price may be based on an exchange rate stability factor with respect to the first currency and the base currency. A determination to override a price that may be generated by automatic multi-currency pricing may be applied to a selection of products or all products of the at least one storefront. The e-commerce platform may be enabled to create a corresponding product variant page for the first jurisdiction. Each product variant page may be provided with associated data including a price, a corresponding date and time the price was set, a corresponding exchange rate application when the price was set and/or whether a price may be set manually or automatically. The pricing engine may be enabled to determine updated recommendations at predetermined intervals. The e-commerce platform may be enabled to receive an updated price for the product in the first currency. The product may be made available in the first jurisdiction if the first price is overridden and an updated price for the product in the first currency has not been received by the e-commerce platform.

In embodiments, a system may include an e-commerce platform comprising at least one processor and at least one memory, wherein the e-commerce platform may be adapted to receive product data corresponding to a product of at least one storefront, wherein the product data relates to a first jurisdiction. A pricing engine may be adapted to determine a recommendation to override or to not override a first price for the product using the product data, wherein the first price for the product is generated using automatic multi-currency pricing in a first currency for a first jurisdiction based on a base price of the product in a base currency and an exchange rate calculation. The e-commerce platform may be adapted to communicate the recommendation to a merchant user associated with the at least one storefront.

The product data may include at least one item from the group consisting of: a cost to supply the product to the first jurisdiction, a factor related to purchasing power of the first jurisdiction, a demand for the product in the first jurisdiction, a supply of the product in the first jurisdiction, a stability factor related to a currency of the first jurisdiction, competitor pricing of the product in the first jurisdiction, a volume of sales of the product in the first jurisdiction, and competitor sales of the product in the first jurisdiction. The product data may include a total cost of the product in the first jurisdiction including any storage costs, tax costs, import costs, local production costs, and labor costs and a recommendation to override the first price may be provided if the total cost of a product is greater than a predetermined amount. The product data may include a number of visitors to the at least one storefront from the first jurisdiction and wherein a recommendation to override the first price may occur if a number of visitors to the at least one storefront from the first jurisdiction is above a predetermined amount and a total amount of sales is below a predetermined value. The product data may include data from multiple storefronts and the pricing engine may be enabled to determine the recommendation by aggregating the data from multiple storefronts according to a selected industry or a classification of product. The product data may include an average total cost of a product in the first jurisdiction across the multiple storefronts including any storage costs, tax costs, import costs, wherein a recommendation to override the first price may occur if local production costs, and labor costs and the average total cost of a product is greater than a predetermined amount. The pricing engine may be enabled to determine the recommendation by examining attitudes toward a product in the first jurisdiction. The pricing engine may be enabled to determine the recommendation using machine learning. The e-commerce platform may be enabled to receive a command for allowing automatic multi-currency pricing prior to or subsequent to providing a recommendation to override the first price. A recommendation to override the first price may occur based on an exchange rate stability factor with respect to the first currency and the base currency. A recommendation to override a price generated by automatic multi-currency pricing may be applied to a selection of products or all products of the at least one storefront. The e-commerce platform may be enabled to create a corresponding product variant page for the first jurisdiction. Each product variant page may be provided with associated data including a price, a corresponding date and time the price was set, a corresponding exchange rate application when the price was set, whether a recommendation to override is provided, and/or whether a price is set manually or automatically. The pricing engine may be enabled to determine updated recommendations at predetermined intervals. The e-commerce platform may be enabled to receive an updated price for the product in the first currency.

### BRIEF DESCRIPTION OF THE FIGURES

FIG. 1 depicts an embodiment of an e-commerce platform.

FIG. 2 depicts an embodiment for a home page of an administrator.

FIG. 3 depicts an embodiment for a functional-flow block diagram for an e-commerce platform with a pricing engine and an exemplary process for providing a recommendation regarding multi-currency pricing.

FIG. 4 depicts an embodiment for a functional-flow block diagram for an e-commerce platform with a pricing engine and an exemplary process for enabling automatic multi-currency pricing.

FIG. 5 depicts an exemplary process for providing a recommendation to override or overriding an automatic multi-currency price for a product.

FIG. 6 depicts an embodiment for a functional-flow block diagram for an e-commerce platform with a pricing engine and an exemplary process for generating product variant pages.

FIG. 7 depicts an exemplary user interface for requesting and displaying pricing recommendations.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

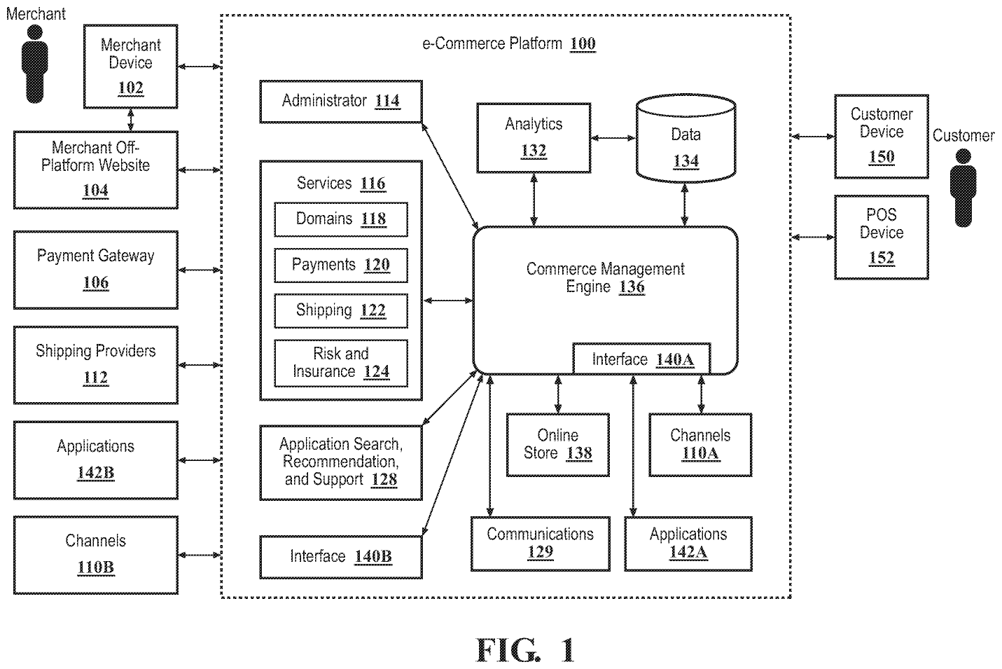

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store). Throughout this disclosure the terms online store 138 and storefront may be used in connection with an online e-commerce presence, an offline commerce presence (such as a physical store), an online channel, an offline channel, a channel 110A internal to the platform 100, a channel 110B external to the platform 100, or the like, or any combination of the foregoing.

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their web site through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

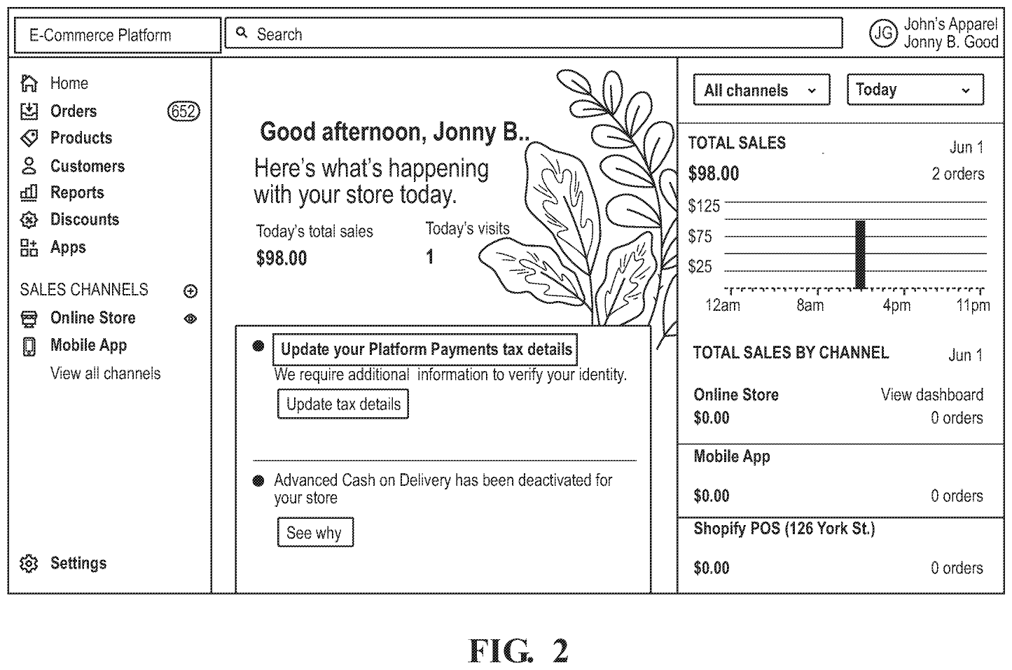

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

In embodiments, the e-commerce platform 100 may evaluate a number of different factors in order to control automatic or dynamic multi-currency pricing, such as to determine when to enable or disable this functionality or to determine a recommendation regarding automatic multi-currency pricing. Further, the e-commerce platform 100 may evaluate a number of different factors to override a price set using automatic multi-currency pricing or provide a recommendation to override such a price. As used herein, automatic multi-currency pricing with respect to a storefront (or more generally an on-line store) refers to having a price for a product set in a base currency (such as U.S. dollars) in one jurisdiction and determining a price in at least one other currency, corresponding to another jurisdiction, typically using the base currency price and an exchange rate converting the base currency price to a price in the other currency. The price displayed to a user viewing the storefront could then depend on the user's jurisdiction, which may be detected by the e-commerce platform. As used herein, a jurisdiction may be any defined area (such as a country, a group of countries, a region of a country, a group of various regions or various countries, or the like) where a particular currency is accepted or used in a de facto manner.

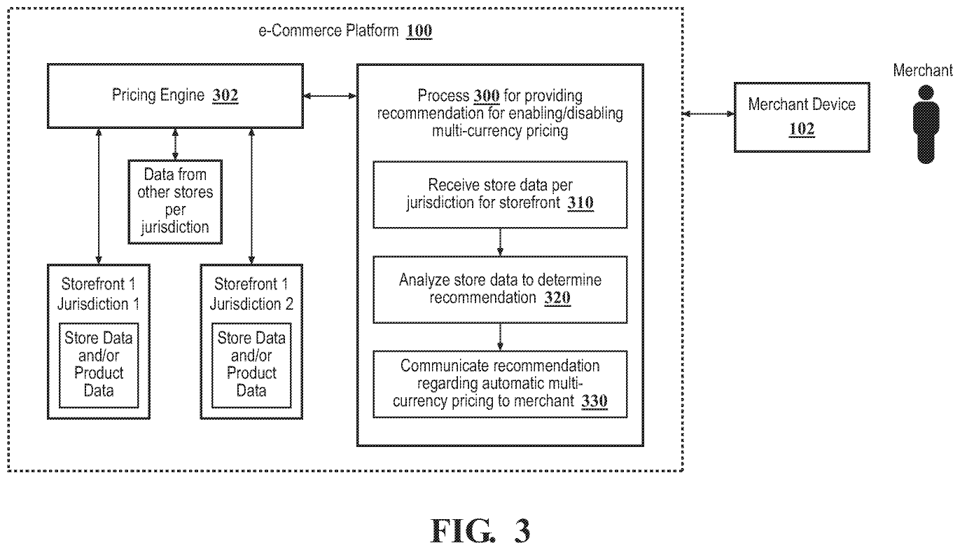

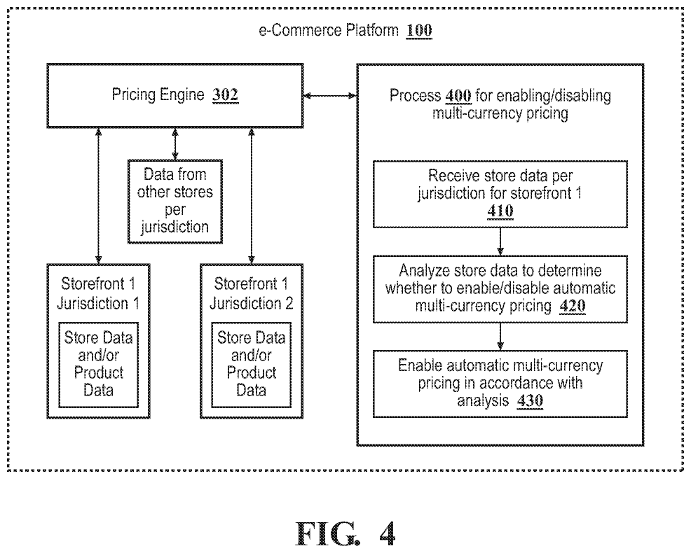

The e-commerce platform 100, such as via a pricing engine 302 as shown in FIGS. 3 and 4, may evaluate various factors related to a product or a storefront offering the product in order to determine when to recommend enabling or disabling or actually enabling or disabling automatic multi-currency pricing for a given currency for a given jurisdiction. Similarly, the e-commerce platform may evaluate various factors in order to determine when to recommend overriding or actually overriding a price set by automatic multi-currency pricing for a product, such that manual pricing in different jurisdictions may be enabled, a different pricing approach may be used or the product may be prevented from being offered for sale in certain jurisdictions. For example, for a merchant selling hiking tours to England, if automatic multi-currency pricing is enabled, the merchant's online storefront may provide tour prices in English pounds to users from Great Britain, in U.S. dollars to users from the U.S., in euros to users from those European countries having the euro as currency, and the like, wherein a corresponding exchange rate (such as dollar to pound, and euros to pound) may be used to automatically calculate the prices in the different currencies for display to the appropriate user. If the automatic multi-currency pricing is overridden or disabled for one or more hiking tours, the prices may be displayed in English pounds for all users, or prices may be manually entered for the different currencies and jurisdictions. Further, a merchant may also choose to not offer certain products in certain jurisdictions. Because it may be time consuming for a merchant to have to manually determine and set corresponding prices for each jurisdiction, especially for storefronts having hundreds or thousands of products in many different jurisdictions, the ability to determine when to enable an automatic multi-currency pricing capability along with the ability to determine when to override a price set or to be set by automatic multi-currency pricing capability for one or more products provides important flexibility and efficiency for a merchant by identifying and considering various important factors relevant to such decisions.

In embodiments, the e-commerce platform may determine when to provide a recommendation to enable or actually enable automatic pricing for one or more products of a storefront in a particular jurisdiction based on an analysis of store data and other data relating to the storefront, including on a per jurisdiction basis.

Various factors may be considered in an analysis of when to enable pricing in a given currency for a given jurisdiction, such as (user or buyer) traffic from or associated with the given jurisdiction. Traffic associated with a jurisdiction may be determined in a variety of ways by the e-commerce platform, such as by determining user locations by using respective IP (Internet Protocol) addresses (IP-based geolocation) or using location tracking data, such as GPS (Global Positioning System) data from mobile devices or other computing devices associated with users; using location or preferred currency information provided by users, such as shipping addresses or currency preferences, using historical purchase data related to users, using a context of search parameters or product viewing or searching history, or the like.

As an example of the use of traffic associated with a jurisdiction in automatically enabling pricing in a given currency, a large spike or sustained build over time of traffic from the U.S. (e.g. as determined to be from a U.S. jurisdiction as described above) to an English storefront selling hiking tours may trigger enabling prices of the hiking tours to be converted from pounds to U.S. dollars to be displayed for those visitors. In some embodiments, more than one factor may be considered in determining which jurisdiction a particular user might be associated with and whether to enable pricing in another currency. In embodiments where multiple factors are used, some factors may be considered to have precedence over others. For example, a user from the U.S. travelling to Europe may be recognized as a U.S. user (and have prices displayed in U.S. dollars) even if an IP location indicates that the user is in Europe, if for example, a shipping address or historical data such as prior purchases in U.S. dollars or other determination indicates the user is actually from the U.S. As another example, a user may be characterized as a Canadian based on a purchase of a flight from Canada, even though a car rental reservation is made in U.S. dollars and searches of tours in New York City form part of the historical data.

Further, analysis of actual sales from a jurisdiction or in a specified currency can also be considered. The analysis may aggregate data across the platform (e.g., from multiple storefronts), such as according to product, type of product, type of industry, class of products, or the like. The analysis may consider what products are selling where or corresponding amounts of traffic from various jurisdictions related to a product or a type of product. For example, aggregate data across the platform may indicate that stores in Germany selling T-shirts are getting more traffic and sales from Mexico, such that the e-commerce platform may turn on automatic multi-currency pricing and shipping to Mexico for a store of a merchant in Germany that sells T-shirts, and perhaps enables or recommends enabling automatic multi-currency price just for T-shirts and not for other products the store sells. The platform may compare data regarding a product from a storefront to aggregated data from multiple storefronts or multiple products to determine statistically significant differences.

In embodiments, the e-commerce platform may automatically enable the multi-currency pricing or provide a recommendation, such as via a user interface for an administrator of the storefront, such as where the recommendation can be accepted and enabled with one click.

FIG. 3 depicts an embodiment for a functional-flow block diagram for an e-commerce platform 100 with a pricing engine 302 and an exemplary process 300 for providing a recommendation regarding multi-currency pricing for one or more products of a storefront for a given jurisdiction. The e-commerce platform 100 may receive and store data related to a storefront and may aggregate data across multiple storefronts. Such data may be store data and/or product data, including per jurisdiction. At a step 310, store data corresponding to one or more storefronts is received and stored (or used if already present) by the e-commerce platform 100, wherein the store data may correspond to a set period of time and may include, for example, a corresponding number of visitors to the one or more storefronts by jurisdiction and/or a corresponding amount of product sold by the one or more storefronts by jurisdiction. For example, corresponding store data for storefront 1 associated with jurisdiction 1 may be received and stored and corresponding store data for storefront 1 associated with jurisdiction 2 may be received and stored. At a step 320, the store data is analyzed to determine a recommendation for the storefront to enable or to disable automatic multi-currency pricing. For example, the e-commerce platform 100 may determine the number of visitors to the storefront from a given jurisdiction, and if the number of visitors from that jurisdiction is above a predetermined amount or a rate of change of the number of visitors to the storefront from that jurisdiction is above a predetermined value, the corresponding recommendation would be to enable automatic multi-currency pricing to price the products in a currency corresponding to the given jurisdiction. In another example, a recommendation to enable automatic multi-currency pricing may be made for a given jurisdiction if an amount of product sold (e.g. a sales value or a number of items of a particular product or product type) in the jurisdiction is above a predetermined value. In yet another example, a recommendation for a given jurisdiction may be made to disable automatic multi-currency pricing if the number of visitors, rate of change of the number of visitors or amount of product sold falls below a predetermined value. The store data may include data from multiple storefronts across the platform such that the analyzing step considers the data from multiple storefronts to determine the recommendation, such as by aggregating the data from multiple storefronts according to industry, classification of product, or the like. Another consideration in the analysis may be an exchange rate stability factor, wherein greater stability and manual pricing may be desirable for jurisdictions with fluctuating currency values. The analysis may also consider factors described elsewhere herein. At a step 330, the recommendation is communicated to a merchant user associated with the storefront, such as by transmitting the recommendation to a merchant device 102 for display. The merchant user associated with the storefront can accept the recommendation to cause the platform to enable or disable automatic multi-currency pricing. When multi-currency pricing is enabled for a given jurisdiction for a storefront, the platform is configured to convert prices from a base currency to a currency of that jurisdiction and present (e.g. display) products along with the converted prices. Conversely, when multi-currency pricing is disabled, the platform is configured to present products with prices in the base currency.

Similarly, FIG. 4 illustrates an exemplary process 400 for enabling automatic multi-currency pricing for one or more products of a storefront for a given jurisdiction. At a step 410, store data corresponding to one or more storefronts is received by the e-commerce platform, wherein the store data includes a corresponding number of visitors to the one or more storefronts by jurisdiction and/or a corresponding amount of product sold by the one or more storefronts by jurisdiction, such as over a set time period. At a step 420, the store data is analyzed to determine whether to enable automatic multi-currency pricing for the storefront, using similar considerations as those described elsewhere herein. For example, the analysis may consider data from multiple storefronts and aggregate the data from multiple storefronts according to a selected industry or classification of product. For example, the platform 100 may be configured to automatically enable multi-currency pricing when a number of visitors to the one or more storefronts from a given jurisdiction is greater than a predetermined amount or a rate of change of the number of visitors to the storefront from the given jurisdiction is greater than a predetermined value. In another example, the platform 100 may also or instead be configured to enable multi-currency pricing if an amount of product sold in the given jurisdiction is above a predetermined value. In other embodiments, if the number of visitors, rate of change of the number of visitors or amount of product sold in a given jurisdiction falls below a predetermined value, the platform 100 may be configured to automatically disable multi-currency pricing.

At a step 430, automatic multi-currency pricing is enabled (or disabled) for one or more products of the storefront in accordance with the results of the analysis. A determination may be made to apply automatic pricing to all products of a storefront. Automatic multi-currency pricing determines a corresponding price for at least one product of the storefront in a different currency than a base currency in which prices are already established, such as by using the base price and an exchange rate between the base currency and the different currency of the given jurisdiction. Similarly to the embodiment of FIG. 3, when multi-currency pricing is enabled for a given jurisdiction, the platform 100 is configured to convert prices from a base currency to a currency of that jurisdiction and present (e.g. display) products along with the converted prices. Conversely, when multi-currency pricing is disabled, the platform is configured to present products with prices in the base currency.

In embodiments, the e-commerce platform 100 may provide a recommendation regarding when to override a price set via automatic multi-currency pricing for a product in a particular jurisdiction. In embodiments, the e-commerce platform identifies products and jurisdictions for which manually setting one or more corresponding prices may be desirable. In certain cases, a need may exist for manually setting an initial price for a certain product in a certain jurisdiction, such as due to regulations in a jurisdiction or the impact of initial or anchor pricing.

Manually setting prices may allow for price stability in various jurisdictions, e.g., the provided prices are static and do not change without merchant action. Also, providing specificity of prices, e.g., that prices provided are exactly what a buyer pays, may also be an important factor. For example, for a hiking tour to England, it may be desirable for a merchant to offer a price of 1500 pounds to users from the United Kingdom, and a price of $1950 to users from the United States, rather than an exchange rate calculated price such as $1956.01, which is not a round number and is dependent on a varying exchange rate.

In embodiments, the e-commerce platform may provide a statistical or other analysis of various factors relating to a given jurisdiction in order to provide a recommendation regarding recommending an override or overriding a price set or to be set via automatic multi-currency pricing. The factors may relate to a given jurisdiction relative to a base or anchor jurisdiction. This analysis may include consideration of such items as a total cost of supplying a product, a demand for the product, an availability of the product, or competitive product pricing in that jurisdiction. For example, the e-commerce platform may evaluate a total cost to provide a product in a jurisdiction, which may include landing costs, taxes, tariffs, import costs, local production, labor costs, etc. Further, differences in purchasing power between jurisdictions, and relative economic strength or weakness between jurisdictions (such as comparing consumers in the U.S. vs. those in India for example) may be considered. Differences in attitudes toward a product may be considered. For example, in a typically hot jurisdiction, the value placed on warm clothing may not be as high as in colder jurisdictions since it may be utilized or needed only sparingly, and thus may be priced lower in the hot climate jurisdiction as compared to a cold jurisdiction, where consumers may be willing to pay a premium price for warm clothing.

An analysis may also consider a particular product or product type, such as its sale history, sales volume, margin, and/or available inventory, for the storefront or across the storefronts of the platform in a particular jurisdiction, or in comparison to other products of the storefront or similar products of other merchants. For example, a high volume of products may warrant a closer or more intentional look at pricing because pricing impact is amplified due to the volume. Another factor to be considered may be the number of visitors to the storefront, or a particular page of the storefront, from a particular jurisdiction. For all the considered factors, a statistical or other analysis may determine when a factor and/or a change in a factor are enough to merit an action or recommendation. The analysis may be based on aggregate data across the platform and may leverage machine learning. The analysis may be conducted in real-time or repeated at selected or predetermined intervals.

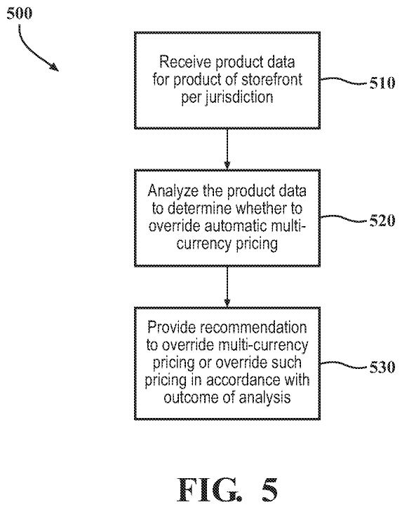

FIG. 5 illustrates an exemplary process 500 for providing a recommendation to override or overriding automatic multi-currency pricing for one or more products of a storefront for a given jurisdiction and may be performed by the e-commerce platform 100. At a step 510, product data corresponding to one or more storefronts of a first jurisdiction is received by the e-commerce platform, wherein the product data may relate to factors such as a cost to supply the product to the first jurisdiction, a factor related to purchasing power of consumers in the first jurisdiction, a demand for the product in the first jurisdiction, a supply of the product in the first jurisdiction, a stability factor related to a currency of the first jurisdiction, competitor pricing of the product in the first jurisdiction, a volume of sales of the product in the first jurisdiction, and competitor sales of the product in the first jurisdiction.

At a step 520, the product data is analyzed to determine whether to override automatic multi-currency pricing for a product, using similar considerations as those described elsewhere herein. For example, the analysis may consider product data from multiple storefronts and aggregate the data from multiple storefronts according to a selected industry or classification of product. Product data may include a total cost of a product in the first jurisdiction and automatic multi-currency pricing may be not recommended or overridden if a total cost is greater than a predetermined amount.

At a step 530, a recommendation to override automatic multi-currency pricing for one or more products of the storefront may be provided or the platform may be configured to actually override automatic multi-currency pricing in accordance with the results of the analysis. In some embodiments, the platform may also be configured to determine an override value or receive an override value from a merchant user in connection with a particular product and/or a particular jurisdiction for which automatic multi-currently pricing was enabled. The platform may also be configured to use the override value to override automatic multi-currency pricing for that particular product or jurisdiction.

In embodiments, the e-commerce platform may also be configured to disable the automatic multi-currency pricing or an existing override, such as to no longer display prices in a certain currency or halting sales as a protection until a merchant provides input. This may be useful for example where the automatic multi-currency pricing results in a pricing value that is too low or inaccurate or no longer suited for a particular product or jurisdiction. In embodiments, the e-commerce platform may provide a recommendation to disable automatic multi-currency pricing or alter an existing override value, which may take the form of a message or popup on a user interface of the administrator of the storefront, where the recommendation could be accepted and enabled with a single click or action. In embodiments, a user associated with the storefront may be allowed to re-enable the automatic multi-currency pricing (or the override) for one or more products.

For example, it may be desirable that automatic multi-currency pricing or override for a product be disabled when a number of visitors to the one or more storefronts (or to a corresponding product page) from a given jurisdiction is greater than a predetermined amount. Similarly, it may be desirable to disable or override automatic multi-currency pricing when a rate of change of the number of visitors to the storefront (or the corresponding product page) from the given jurisdiction is greater than a predetermined value. Automatic multi-currency pricing (or override) for a product may be disabled if an amount of product sold in the given jurisdiction is above a predetermined value and/or within a predetermined period of time. The analyzing step may examine differences of attitudes toward a product in the different jurisdictions. As an example, overriding may be recommended or occur in such situations such as when a product appears to be priced too low given labor costs in a jurisdiction and sales of the product appear to be surging. The analysis may have as its goal protecting the merchant from losing money. In such a case, it may be desirable to override automatic pricing or pull the product from sale in the jurisdiction in any currency and flag the product for the merchant, until the merchant is able to review and perhaps price the product manually. This may prevent the merchant from losing money by selling a product, especially at a high volume at a price that is too low.

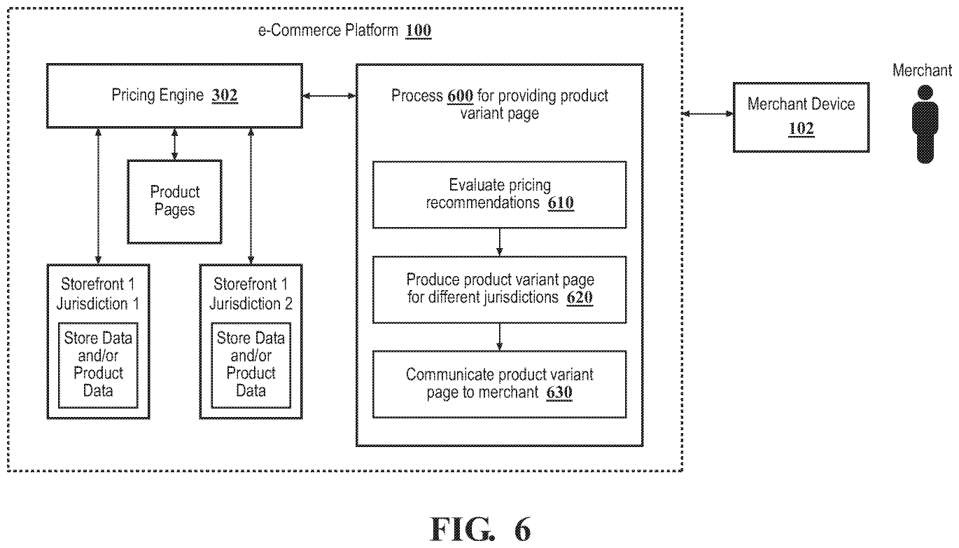

As shown in FIG. 6, the e-commerce platform 100 may be enabled to perform process 600 to produce product variant pages for each product of a storefront, such as one product variant page per jurisdiction. At a step 610, the e-commerce platform may evaluate the multi-currency pricing decisions that occur automatically as a result of an analysis and manual pricing in order to generate at a step 620, appropriate product variant pages for other jurisdictions.

For example, a data record model of the product variant page (which may be created by a process other than process 600) may include various types of data, such as a corresponding price for the product in the currency of the jurisdiction, a date and a time the price was set, an corresponding exchange rate at the date and time the price is set, whether the price was set automatically or manually, any associated recommendations that were provided with respect to enabling or disabling automatic multi-currency pricing, whether the provided recommendations were followed or not, and the like. The data may include historical data providing changes over time and may function as an audit log for each data field/item.

At a step 630, the product variant pages may be communicated to the merchant or to a corresponding storefront via a user interface of a merchant device 102.

In embodiments, the e-commerce platform may be provided with a timer that can be set to revisit and assess an impact of accepting or not accepting a recommendation and/or to evaluate the effectiveness of the recommendation.

In embodiments, control over multi-currency pricing may provide advantages such as limiting or preventing arbitrage by buyers because the e-commerce platform has the ability to limit or select the jurisdictions to which a product variant page is presented. In embodiments, shipping to a particular jurisdiction may be limited or prevented based on a corresponding currency of purchase or price displayed.

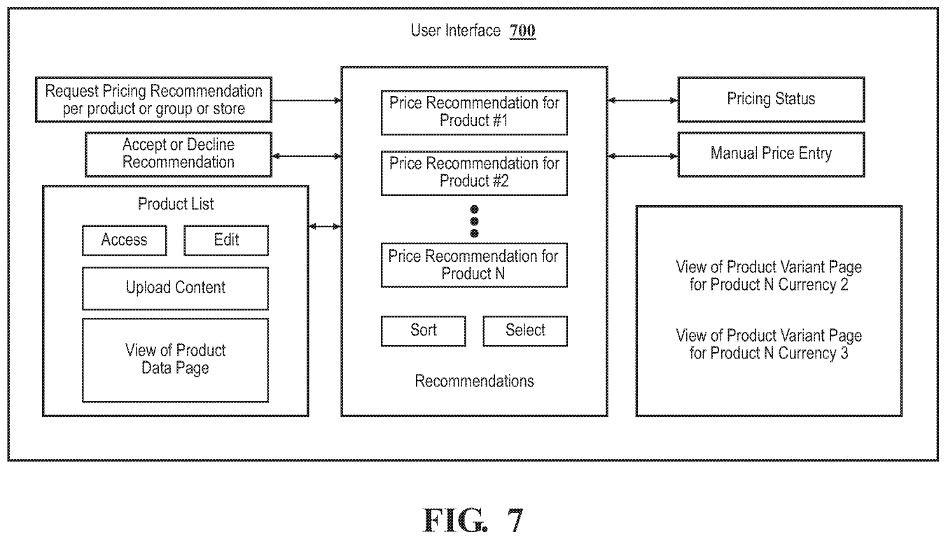

Referring to FIG. 7, in embodiments a user interface 700 may be provided, such as to allow a user to request recommendations regarding enabling or disabling multi-currency pricing or overriding an automatically set price. The user interface may display recommendations, allow a user to accept or decline recommendations, display a status of pricing, such as on a per-product, per-group, or per storefront basis, along with corresponding jurisdiction, allow for a user to enter a manual price, and the like. The user interface may also display product pages and product variant pages, along with corresponding prices in different currencies.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4^{th} Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method comprising:
receiving, by an e-commerce platform, store data corresponding to at least one storefront, wherein the store data includes at least one of: a corresponding number of visitors to the at least one storefront by jurisdiction and a corresponding amount of product sold by the at least one storefront by jurisdiction;
determining, by the e-commerce platform, a recommendation for the at least one storefront to enable or to disable automatic multi-currency pricing using the store data, wherein automatic multi-currency pricing determines a price for at least one product of the at least one storefront in a second currency for a second jurisdiction based on a price of the product in a base currency for a first jurisdiction; and
communicating, by the e-commence platform, the recommendation to a merchant user associated with the at least one storefront.

2. The computer-implemented method of claim 1, wherein determining the recommendation considers a number of visitors to the at least one storefront from the second jurisdiction.

3. The computer-implemented method of claim 2, wherein a recommendation to enable automatic multi-currency pricing occurs if a number of visitors to the at least one storefront from the second jurisdiction is above a predetermined amount or a rate of change of the number of visitors to the at least one storefront from the second jurisdiction is above a predetermined value.

4. The computer-implemented method of claim 1, wherein a recommendation to enable automatic multi-currency pricing occurs if the amount of product sold in the second jurisdiction is above a predetermined value.

5. The computer-implemented method of claim 1, wherein the store data includes data from multiple storefronts and determining the recommendation considers the data from multiple storefronts.

6. The computer-implemented method of claim 5, wherein determining the recommendation comprises aggregating the data from multiple storefronts according to a selected industry or a classification of product.

7. The computer-implemented method of claim 5, wherein determining the recommendation considers a number of visitors to the multiple storefronts from the second jurisdiction.

8. The computer-implemented method of claim 7, wherein a recommendation to enable multi-currency pricing occurs if a number of visitors to the at least one storefront from the second jurisdiction is above a predetermined amount or a rate of change of the number of visitors to the at least one storefront from the second jurisdiction is above a predetermined value.

9. The computer-implemented method of claim 1, wherein the store data includes data from multiple storefronts and determining the recommendation comprises aggregating the data from multiple storefronts according to a selected industry or a classification of product, and wherein a recommendation to enable multi-currency occurs if an amount of product sold in the second jurisdiction for the multiple storefronts is above a predetermined value.

10. The computer-implemented method of claim 1, wherein a corresponding price for a product in the base currency or the second currency is set using an exchange rate between the base currency and the second currency.

11. The computer-implemented method of claim 1, further comprising creating, by the e-commerce platform, a product variant page for the second jurisdiction.

12. The computer-implemented method of claim 11, further comprising providing associated data for the product variant page including at least one item selected from the group consisting of: a price, a corresponding date and time the price was set, a corresponding exchange rate application when the price was set, whether a price is set manually or automatically, and whether a recommendation to enable multi-currency pricing was followed.

13. The computer-implemented method of claim 1, wherein determining the recommendation is repeated at predetermined intervals.

14. The computer-implemented method of claim 1, wherein the store data corresponds to at least one storefront over a set period of time.

15. A system comprising:
an e-commerce platform comprising at least one processor and at least one memory, the e-commerce platform adapted to receive store data corresponding to at least one storefront, wherein the store data includes at least one of: a corresponding number of visitors to the at least one storefront by jurisdiction and a corresponding amount of product sold by the at least one storefront by jurisdiction; and
a pricing engine adapted to determine a recommendation for the at least one storefront to enable or to disable automatic multi-currency pricing using the store data, wherein automatic multi-currency pricing determines a price for at least one product of the at least one storefront in a second currency for a second jurisdiction based on a price of the product in a base currency for a first jurisdiction, and
wherein the e-commerce platform is adapted to communicate the recommendation to a merchant user associated with the at least one storefront.

16. The system of claim 15, wherein the recommendation is determined by considering a number of visitors to the at least one storefront from the second jurisdiction.

17. The system of claim 16, wherein a recommendation to enable automatic multi-currency pricing occurs if a number of visitors to the at least one storefront from the second jurisdiction is above a predetermined amount or a rate of change of the number of visitors to the at least one storefront from the second jurisdiction is above a predetermined value.

18. The system of claim 15, wherein a recommendation to enable automatic multi-currency pricing occurs if the amount of product sold in the second jurisdiction is above a predetermined value.

19. The system of claim 15, wherein the store data includes data from multiple storefronts and the recommendation is determined by considering the data from multiple storefronts.

20. The system of claim 19, wherein the recommendation is determined by aggregating the data from multiple storefronts according to a selected industry or a classification of product.

21. The system of claim 20, wherein the recommendation is determined by considering a number of visitors to the multiple storefronts from the second jurisdiction.

22. The system of claim 21, wherein a recommendation to enable multi-currency pricing occurs if a number of visitors to the at least one storefront from the second jurisdiction is above a predetermined amount or a rate of change of the number of visitors to the at least one storefront from the second jurisdiction is above a predetermined value.
